(19) United States
(12) Patent Application Publication
(10) Pub. No.: US 2009/0121091 A1
(43) Pub. Date: May 14, 2009

(54) Device for Guiding Cables or Wires

(76) Inventors: Oskar Elm, Eschenburg (DE); Matthias Muller, Dillenburg (DE); Horst Besserer, Herborn (DE); Benner Rolf, Herborn-Amdorf (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 12/083,850

(22) PCT Filed: Nov. 15, 2006
(86) PCT No.: PCT/EP2006/010938

§ 371 Date: Apr. 18, 2008

(30) Foreign Application Priority Data
Nov. 25, 2005 (DE) 10 2005 056 214.0

(51) Int. Cl. F16L 5/02; F16L 5/00

(52) U.S. Cl. 248/57

(57) ABSTRACT

A device used to guide cables or wires through walls. The device includes a maintaining device connected to two or more cable maintaining elements. The maintaining elements surround, in a frame-like manner, a through-opening, and the cable maintaining elements are arranged in the region of the through opening. According to this invention, at least one of the cable maintaining devices or at least two groups of cable maintaining devices can be connected to the maintaining device independently from one or more of the remaining cable maintaining devices by connecting elements which are associated with the cable maintaining devices, in order to improve the ease of mounting of this type of device.

### BACKGROUND OF THE INVENTION

1. Field of the Invention

This invention relates to a device for guiding cables or wires through walls, having a holding device, with which two or more cable holders are connected, wherein the holding device surrounds a feed-through opening in a frame-like manner, and the cable holders are arranged in the area of this feed-through opening.

2. Discussion of Related Art

A device is known from German Patent Reference DE 92 11 740 U1. Here, a frame-like holding device is used and forms the feed-through opening. The holding device has a circumferential strip surrounding the feed-through opening. Cable holders made of an elastic rubber material can be placed on this strip.

The cable holders cover a partial area of the feed-through opening. A bracing element is placed into the remaining partial area, by which the individual cable holders can be braced transversely with respect to the cable feed-through opening direction.

It is not possible with this device to use the partial area into which the bracing element is inserted for cable guidance. For bracing it, the bracing element must be accessible from the front and rear of the device.

In the installed state, it is necessary to keep the wall in which the device is installed accessible at the rear. Also, two persons are required for the mounting operation. One person braces the bracing elements at the front, and a second person stands behind the wall and counters the bracing element.

With the bracing element released, it can occasionally occur that the cable holders fall uncontrolled out of the holding device, so that the mounting has no problems.

### SUMMARY OF THE INVENTION

It is one object of this invention to provide a device of the type mentioned above but which is distinguished by an ease of operating.

This object is attained if at least one of the cable holders, or at least two groups of cable holders, can be connected, independently of the one or the remaining cable holders, with the holding device by connecting elements assigned to the cable holders.

The user can release the desired cable holder in a directed manner because individual cable holders are fixed in place on the holding device by individually assigned connecting elements. The remaining cable holders remain fixed in place. The manipulation of the device is thus clear and assembling or disassembling of the cable holders is possible in a simple manner.

In accordance with this invention, it is possible to assign respectively one connecting element to each cable holder, or a group of cable holders can be fixed in place by a connecting element.

In accordance with a preferred embodiment of this invention, the holding device has a wall attachment side, by which it can be connected with a wall, the connecting elements are releasably connected with the holding device via a locking arrangement, and the connecting element can be displaced into the locking position, or released therefrom, from the side facing away from the wall attachment side.

Thus, the cable holders can always be released or fixed in place from the direction of the front of the wall, which allows a one-person mounting. Also, the installation conditions on the rear of the wall can be designed independently of the cable passage.

In order not to restrict the free passage of cables equipped with plugs through the feed-through opening, in accordance with this invention, the connecting elements are arranged outside of the feed-through opening.

A dependable support and strain relief of the cable holders simply results if the cable holders are positively connected in the cable feed-through direction with the holding device and are supported opposite the cable feed-through direction by each of the connecting elements.

It is thus possible for the cable holders to be placed with a support section on a support section which surrounds the feed-through opening at least in part, and for a fastening piece of the connecting elements to extend over the cable holders on their side facing away from the support section.

A simple locking of the connecting element without the use of tools can be achieved if in the locked position the connecting element is fixed in place on the holding device by a snap-in connection.

It is possible to achieve an exact positioning of the cable holders and to maintain it if the connecting elements and/or the holding device have positional receptacles at which the cable holders are maintained transversely to the cable feed-through direction.

A dependable sealing of the cable holders can be achieved if the holding device and/or the connecting elements have clamping pieces, which sealingly brace the cable holders in the mounted position transversely to the cable feed-through direction. In this way, a functional separation of locking and sealing is achieved by the connecting elements and the clamping pieces.

It is thus possible to achieve a large degree of IP sealing if the holding device supports the clamping pieces, the clamping pieces can be displaced transversely with respect to the cable feed-through direction, and in the mounted position the displacement movement of the clamping pieces is blocked by the connecting elements.

In accordance with a preferred embodiment of this invention, the cable holders have a non-deformable cable enclosure body, which is circumferentially surrounded by a seal and is maintained on the holding device, and the seal is placed against a circumferential sealing face of the holding device and against the seals of the one or several adjoining cable holders, the rigid cable enclosure body, which for example can include one or several plastic injection-molded parts, can be dependably supported on the holding device. For performing its function, the properties and shape of the seal can then be designed independently of the cable enclosure body.

In a conceivable embodiment of this invention, the cable holder includes a cable enclosure body, which surrounds at least one cable feed-through and has two or more partial bodies, which can be adjusted with respect to each other, by which the cable feed-through can be opened transversely to the cable feed-through direction, and the cable enclosure body is directly fixed in place on the holding device.

It is thus possible to insert pre-assembled cables with plugs already placed on them into the cable feed-through of the cable enclosure body which can be opened. Because the cable enclosure body is directly connected with the holding device, it is possible to accomplish a simple compact construction with few components.

### BRIEF DESCRIPTION OF THE DRAWINGS

This invention is explained in greater detail in view of exemplary embodiments represented in the drawings, wherein:

FIG. 1 is a lateral view of a holding device for conducting cables or wires through a wall;

FIG. 2 shows the holding device in accordance with FIG. 1, in a top view;

FIG. 3 shows the holding device in accordance with the section line identified by III-III in FIG. 2;

FIG. 4 shows the holding device in accordance with FIGS. 1 to 3, in an isometric view;

FIG. 5 shows a cover in an isometric view;

FIG. 6 shows the cover in accordance with FIG. 5, taken along the section line identified by VI-VI in FIG. 7;

FIG. 7 shows the cover in a top view;

FIG. 8 shows an arrangement with the holding device in accordance with FIGS. 1 to 4 and with the cover in accordance with FIGS. 5 to 7, as well as with a cable holder and a connecting element, taken along the section line identified by VIII-VIII in FIG. 9;

FIG. 9 shows the arrangement in accordance with FIG. 8, in a top view;

FIG. 10 shows the arrangement in accordance with FIG. 9, taken along the section line identified by X-X in FIG. 9; and

FIGS. 11 to 15 show a connecting element in various views.

### DETAILED DESCRIPTION OF THE INVENTION

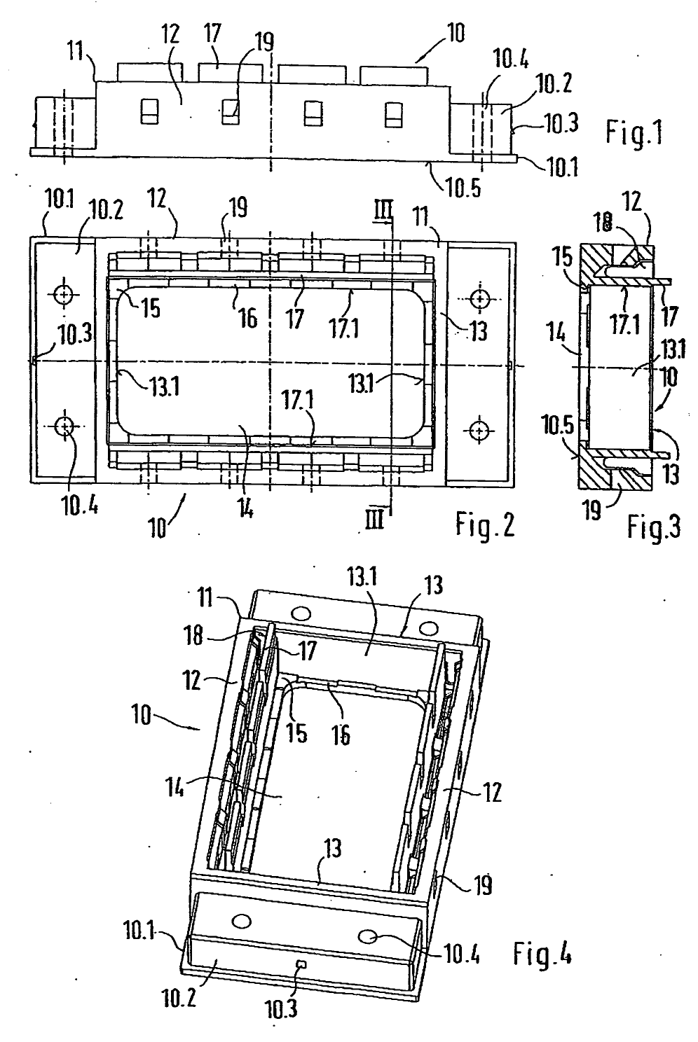

A holding device 10 embodied as a one-piece plastic injection-molded part is shown in FIGS. 1 to 4. With lateral elements 12 and 13 extending in the linear and transverse direction, the holding device 10 forms a frame 11 that surrounds a feed-through opening 14. In this case, the feed-through opening 14 is only bordered by a support section 15, which projects at a right angle away from the lateral elements 12, 13. On its front, the support section 15 has positioning receptacles 16 designed as recesses that are spaced apart from each other in a modular dimension.

As FIG. 3 shows, clamping pieces 17 are formed on the lateral elements 12 in the connecting area of the support section 15. Here, the clamping pieces 17 extend continuously between the lateral elements 13, and their ends are connected with them. In this way, the clamping pieces 17 and the lateral elements 13 form a circumferential sealing face 17.1, 13.1 facing the feed-through opening 14. The clamping pieces 17 protrude with gripping elements from the front of the holding device 10. In the area facing away from the feed-through opening 14, a free space 18 is formed at the rear behind the clamping pieces 17. The clamping pieces 17 are or can be pivoted in a spring-elastic manner into it around the connecting section formed in the transition area between the clamping pieces 17 and the support section 15.

The lateral elements 13 have two shoulders 10.1, which face away from the feed-through opening 14 and which are embodied in a box shape and are bordered by a protruding edge 10.1 and two screw receptacles 10.4 penetrate through them.

The shoulders 10.2 are respectively laterally equipped with a snap-in element 10.3. As shown in FIG. 3, for example, the holding device 10 has a wall attachment side, which is formed by a flat contact face 10.5. With this contact face 10.5 it is possible, with the interposition of a seal, to attach the holding device 10 around a wall opening to a wall so that the wall opening and the feed-through opening 14 are aligned.

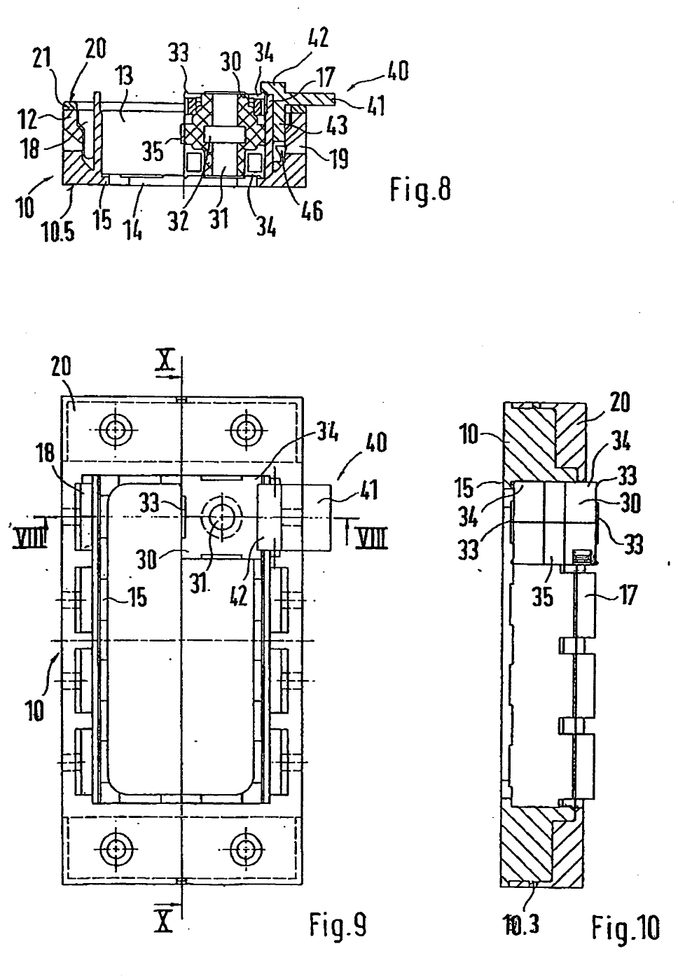

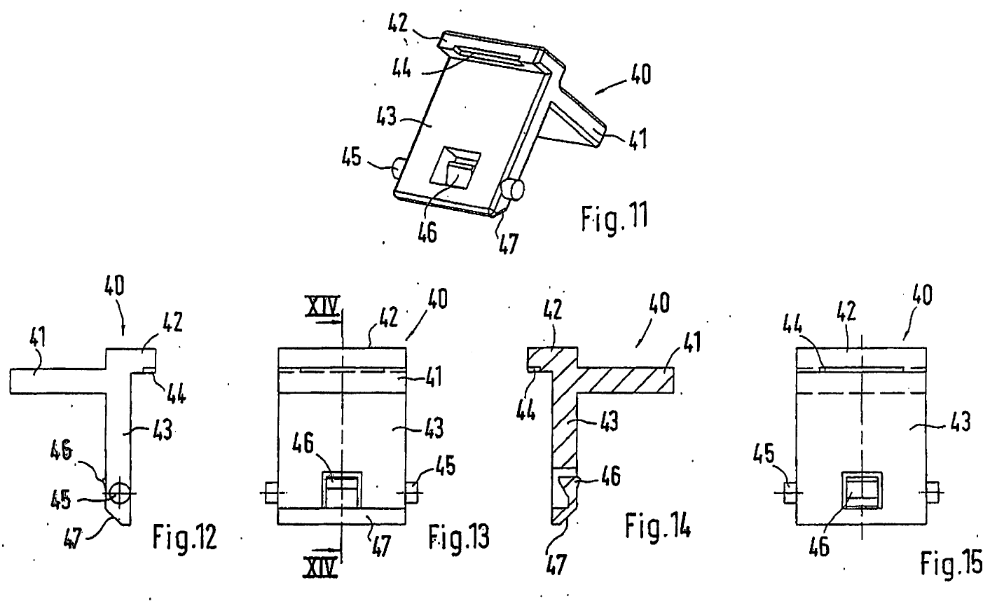

As FIG. 8 shows, it is possible to introduce connecting elements 40 into the free space 18 behind the clamping pieces 17. The details of the design of the connecting elements 40 can be taken from FIGS. 11 to 15. As these drawings show, the connecting element 40 has a strip 43 and a handle 41 formed at right angles on it. The strip 43 also has a fastening piece 42 on the side facing away from the handle 41 which is also arranged at right angles with respect to the strip 43. On an underside the fastening piece 42 has a recess 44, with dimensions that correspond to the positioning receptacles 16 of the support section 15 of the holding device 10.

On its end facing away from the fastening piece 42, the strip 43 has an opening, at which it supports a snap-in element 46 formed on it. An obliquely-shaped element 47, as well as two laterally projecting stops 45, are also provided in the area of or near the free end of the strip 43. The stops 45 are embodied as cylindrical pegs.

As FIG. 8 shows, the strip 43 of the connecting elements 40 can be inserted into the free space 18. In the area facing the contact face 10.5, the free space 18 is delimited by an oblique surface, which works together with the obliquely-shaped element 47 of the connecting element 40. Accordingly, the obliquely-shaped element 47 slides up on the oblique surface, so that in the assembled position the strip 43 rests against the back of the clamping piece 17. The snap-in element simultaneously snaps into an associated snap-in receptacle 19, which is cut in the form of an opening into the lateral element 12 of the holding device 10.

Snapping-in can be accomplished in a simple manner if the connecting element 40 is merely pushed into the free space 18 with the aid of the handle 41.

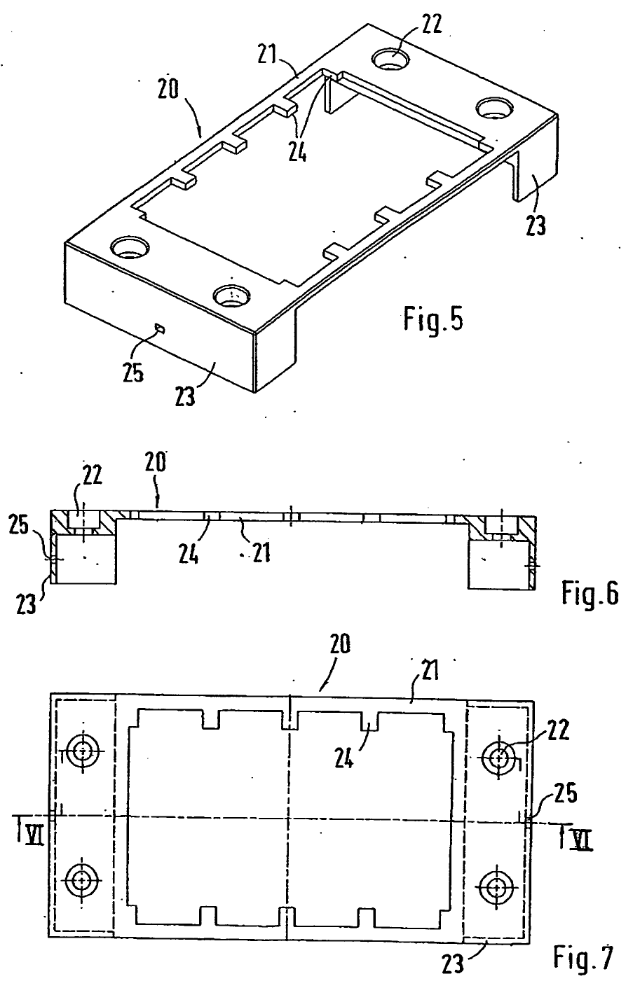

As FIG. 8 shows, a cover 20 is connected with the holding device 10, which fixes the connecting elements 40 directly on the holding device 10 in a manner secure against loss. The embodiment of the cover 20 is shown in detail in FIGS. 5 to 7. As FIG. 5 shows, the cover 20 has two strips 21, which are arranged parallel with respect to each other and have comb-like protrusions 24. On their longitudinal ends the strips 21 are connected with box-like borders 23. Screw receptacles 22 pass through the borders 23.

The cover 20 can be placed on the holding device 10 and during this the borders 23 extend around the shoulders 10.2 of the holding device 10. The cover 20 can be pushed onto the holding device 10 until it makes contact with the edge 10.1. In this position, the snap-in elements 10.3 of the holding device 10 snap into snap-in receptacles 25 of the cover 20, so that the cover 20 is maintained secure against loss. In this case, the screw receptacles 22 of the cover 20 are also arranged aligned with the screw receptacles 10.4 of the holding device 10.

As FIG. 8 shows, the strips 21 of the cover 20 are placed on the lateral elements 12 of the holding device 10, and the protrusions 24 cover the free space 18. The distance between the protrusions 24 is matched to the spacing of the stops 45 of the connecting element 40. The connecting element 40 can be brought out of the locking position represented in FIG. 8 into an unlocked position. To this end, the snap-in element 46 is released by a suitable tool pushed through the snap-in receptacle 19, and the connecting element 40 can be pulled out in the direction facing away from the contact face 10.5 with the aid of the handle 41. The pull-out movement is limited by the stops 45, which come to rest against the protrusions 24 of the cover 20.

As FIG. 8 shows, the free space 18 is widened in the area facing the cover 20, so that in the pulled-out state the connecting element 40 can be pivoted outward to a limited extent in the direction of the extension of the handle 41. Then the fastening piece 42 is located outside of the cable feed-through area, so that cable holders 30 can be comfortably inserted.

FIGS. 8 to 10 show the design of the cable holders 30 which include two cable halves, which can be snapped together. The cable holder 30 encloses a cable feed-through 31. A sealing element receptacle 32 is provided, centered in the cable feed-through 31. A sealing element is inserted into the latter and sealingly encloses a cable inserted into the cable feed-through 31. The cable holder 30 forms a strain relief, which fixes the cable in place so it cannot be axially shifted. At their longitudinal ends, the cable holders 30 form support sections 34 with shoulders 33 formed thereon around the cable feed-through 31. The dimensions of the shoulders 33 are matched to the shape of the positioning receptacles 16 of the holding device 10, or to the recesses 44 of the connecting elements 40.

The cable holders 30 are embodied symmetrically with respect to the center transverse plane. A circumferential sealing element 35 made of a flexible material surrounds the cable holder 30 in the center transverse plane.

The procedure for mounting the device for the feed-through of cables is described as follows.

Initially, the housing halves of the cable holder 30 are placed around a cable, which can have pre-installed plugs, and are snapped together. Then the cable is sealingly fixed in place. Thereafter the cable, if applicable together with the plug, is pushed through the feed-through opening 14. The feed-through opening is sufficiently large so that even large-size plugs can be inserted. Subsequently, the cable holder 30 is placed into the desired position at the holding device 10. In this case, the support section 34 of the cable holder 30 is seated on the support section 15 of the holding device 10. Here, exact positioning is achieved by shoulders 33 of the cable holder 30, which engage the positioning receptacles 16 of the support section 15. Thereafter, the associated connecting element 40 is pushed into the locking position by the handle 41. In the process, the shoulder 33 facing the fastening piece 42 of the connecting element 40 engages the recess 44. In the mounted position, the cable holder 30 is positively fixed in place in the direction of the cable feed-through on the fastening piece 42 and the support section 15.

Additional cable holders 30 or blank pieces are inserted, besides the cable holder 30 as shown in FIG. 9.

In this case, the cable holders 30 can all have the same geometry, or cable holders 30 are employed, which occupy several installation locations in the holding device 10. Here, the dimensions of the cable holders 30 extending in the drawing plane and represented in accordance with FIG. 9 are selected to be kit-like in the longitudinal and the transverse direction.

Accordingly, the longitudinal and/or transverse extension always corresponds to a whole-number multiple of the cable holders 30 as shown in FIG. 9.

In other words, the dimensions of the cable holders 30 are always selected so that the longitudinal and/or transverse extension corresponds to a whole-number multiple of the grid pattern predetermined by the positioning receptacles 16.

Thus, it is possible to fill the cable feed-through area completely with cable holders 30 or, in case no cable feed-through is desired, with blank pieces. At least one connecting piece 40 is assigned to each cable holder 30 or blank piece.

In the contact area with the holding device 10, the cable holders 30, or the blind pieces, are sealed by a circumferential seal 35 against the sealing face 13.1, or 17.1, of the holding device 10. The adjoining cable holders 30 or blank pieces provide sealing by seals 35 placed against each other.

As mentioned above, the device can be installed surrounding a wall opening in a wall. Thus, screws are extended through the screw receptacles 24 of the cover and the screw receptacles 10.4 of the holding device 10 aligned therewith, and are braced in the wall.

1. A device for guiding cables or wires through walls, comprising a holding device (10) with which at least two cable holders (30) are connected, the holding device (10) surrounding a feed-through opening (14) in a frame manner, cable holders (30) arranged near the feed-through opening (14), wherein at least one of the cable holders (30) or at least two groups of cable holders (30) are respectively connected independently of the at least one cable holder (30) or the remaining cable holders (30) with the holding device (10) by connecting elements (40) assigned to the cable holders (30), and the connecting elements (40) arranged outside of the feed-through opening (14) and having a fastening piece (42) extending over the cable holder (30).

2. The device in accordance with claim 1, wherein the holding device (10) has a wall attachment side by which it can be connected with a wall, the connecting elements (40) are releasably connected with the holding device (10) via a locking arrangement, and the connecting element (40) is displaceable into a locking position or released from a side facing away from the wall attachment side.

3. The device in accordance with claim 2, wherein the connecting elements (40) are arranged outside of the feed-through opening.

4. The device in accordance with claim 3, wherein in a cable feed-through direction the cable holders (30) are positively connected with the holding device (10) and are supported opposite the cable feed-through direction by the connecting elements (40).

5. The device in accordance with claim 4, wherein with a support section (34) the cable holders (30) are placed on a support section (15) which at least partly surrounds the feed-through opening (14), and a fastening piece (42) of the connecting element (40) extends over the cable holders (30) on a side facing away from the support section (34).

6. The device in accordance with claim 5, wherein in the locked position the connecting element (40) is fixed in place on the holding device (10) by a snap-in connection.

7. The device in accordance with claim 6, wherein at least one of the connecting elements (40) and the holding device (10) have positioning receptacles (16), at which the cable holders (30) are maintained transversely with respect to the cable feed-through direction.

8. The device in accordance with claim 7, wherein at least one of the holding device (10) and the connecting elements (40) have clamping pieces (17) which sealingly brace the cable holders (30) in a mounted position transversely with respect to the cable feed-through direction.

9. The device in accordance with claim 8, wherein the holding device (10) supports the clamping pieces (17), the clamping pieces (17) are displaceable transversely with respect to the cable feed-through direction, and in the mounted position, a displacement movement of the clamping pieces (17) is blocked by the connecting elements (40).

10. The device in accordance with claim 9, wherein the cable holders (30) have a non-deformable cable enclosure body circumferentially surrounded by a seal (35) and maintained on the holding device (10), and the seal (35) is placed against a circumferential sealing face of the holding device (10) and against the seals (35) of the at least one adjoining cable holders (30).

11. The device in accordance with claim 10, wherein the cable holder (30) includes a cable enclosure body which surrounds at least one cable feed-through (31) and has at least two partial bodies adjustable with respect to each other by which the cable feed-through (31) can be opened transversely with respect to the cable feed-through direction, and the cable enclosure body is directly fixed in place on the holding device (10).

12. The device in accordance with claim 1, wherein the connecting elements (40) are arranged outside of the feed-through opening.

13. The device in accordance with claim 1, wherein in a cable feed-through direction the cable holders (30) are positively connected with the holding device (10) and are supported opposite a cable feed-through direction by the connecting elements (40).

14. The device in accordance with claim 1, wherein with a support section (34) the cable holders (30) are placed on a support section (15) which at least partly surrounds the feed-through opening (14), and a fastening piece (42) of the connecting element (40) extends over the cable holders (30) on a side facing away from the support section (34).

15. The device in accordance with claim 1, wherein in the locked position the connecting element (40) is fixed in place on the holding device (10) by a snap-in connection.

16. The device in accordance with claim 1, wherein at least one of the connecting elements (40) and the holding device (10) have positioning receptacles (16), at which the cable holders (30) are maintained transversely with respect to the cable feed-through direction.

17. The device in accordance with claim 1, wherein at least one of the holding device (10) and the connecting elements (40) have clamping pieces (17) which sealingly brace the cable holders (30) in a mounted position transversely with respect to a cable feed-through direction.

18. The device in accordance with claim 17, wherein the holding device (10) supports the clamping pieces (17), the clamping pieces (17) are displaceable transversely with respect to the cable feed-through direction, and in the mounted position, a displacement movement of the clamping pieces (17) is blocked by the connecting elements (40).

19. The device in accordance with claim 1, wherein the cable holders (30) have a non-deformable cable enclosure body circumferentially surrounded by a seal (35) and maintained on the holding device (10), and the seal (35) is placed against a circumferential sealing face of the holding device (10) and against the seals (35) of the at least one adjoining cable holders (30).

20. The device in accordance with claim 1, wherein the cable holder (30) includes a cable enclosure body which surrounds at least one cable feed-through (31) and has at least two partial bodies adjustable with respect to each other by which the cable feed-through (31) can be opened transversely with respect to a cable feed-through direction, and the cable enclosure body is directly fixed in place on the holding device (10).
